(19) United States
(12) Patent Application Publication
(10) Pub. No.: US 2019/0061818 A1
(43) Pub. Date: Feb. 28, 2019

(54) STEERING ASSIST APPARATUS

(71) Applicant: TOYOTA JIDOSHA KABUSHIKI KAISHA, Toyota-shi (JP)

(72) Inventor: Yu HIEI, Toyota-shi (JP)

(73) Assignee: TOYOTA JIDOSHA KABUSHIKI KAISHA, Toyota-shi (JP)

(21) Appl. No.: 16/110,443

(22) Filed: Aug. 23, 2018

(30) Foreign Application Priority Data
Aug. 30, 2017 (JP) 2017-165635

(51) Int. Cl. B62D 15/02; F16H 63/40

(52) U.S. Cl. CPC B62D 15/027; F16H 63/40

(57) ABSTRACT

Provided is a steering assist apparatus including: a detector configured to detect an own-vehicle peripheral state of an own-vehicle; a mode selector configured to select any one of a parallel exit-from-parking-space mode and a parking mode as a mode based on the own-vehicle peripheral state detected by the detector; and a steering assist device configured to set a target path to a target position, and assist a steering operation of a driver in such a manner that the own vehicle travels along the target path. The mode selector selects any one the parallel exit-from-parking-space mode and the parking mode based on the own-vehicle peripheral state detected by the detector.

### BACKGROUND OF THE INVENTION

### 1. Field of the Invention

The present disclosure relates to a steering assist apparatus configured to assist/support a steering operation of a driver when a vehicle is parked and when the vehicle is caused to exit from a parking space.

### 2. Description of the Related Art

Hitherto, there is proposed a steering assist apparatus configured to assist a steering operation of a driver when a vehicle is parked (or exits from a parking space) (for example, refer to US 2013/0073119 A1).

The steering assist apparatus uses ultrasonic sensors, cameras, and the like to detect a region in which obstacles are not present, and sets a target position of the vehicle to be reached when the vehicle completes the parking (or completes exiting from a parking space) in the detected region. Then, the steering assist apparatus sets a target path to the target position, and performs a steering assist control in such a manner that the vehicle travels along the target path.

When a steering assist button for starting the steering assist control is depressed/operated, the apparatus proposed in US 2013/0073119 A1 (hereinafter referred to as “related-art apparatus”) selects either a parking assist mode (hereinafter referred to as “parking mode”) or a parking exit assist mode (hereinafter referred to as “exit-from-parking-space mode”). The parking mode is a mode for assisting a steering operation when the vehicle is parked. The exit-from-parking-space mode is a mode for assisting a steering operation when the vehicle exits from a parking space. Specifically, the related-art apparatus selects the parking mode when an ignition switch is in an on state and a travel distance after the ignition switch was turned into the on state is longer than a predetermined threshold. Meanwhile, the related-art apparatus selects the exit-from-parking-space mode when the ignition switch is in the on state and the travel distance after the ignition switch was turned into the on state is equal to or shorter than the predetermined threshold.

However, the related-art apparatus may select a mode which the driver does not intend to choose in the following case. For example, as illustrated in FIG. 5, there is a case in which the driver temporarily turns off the ignition switch of the vehicle in front of his or her own house 501, and carries out work (for example, work carried out by the driver to unload the vehicle, or work to open a gate 502 of a garage). After the driver finishes the work, the driver turns on the ignition switch, and depresses the steering assist button to park the vehicle in a parking-possible region 503 in which the vehicle can be parked. In this case, the travel distance after the ignition switch turned into the on state is shorter than the predetermined threshold, and the related-art apparatus thus selects the exit-from-parking-space mode. Even when the driver is requesting the steering assist with the intention to park the vehicle, the related-art apparatus may select the exit-from-parking-space mode in the manner as described above. Thus, the related-art apparatus is not configured to select an appropriate mode in the above-mentioned case.

### SUMMARY OF THE INVENTION

One or more embodiments described below have been devised in view of the above-mentioned problem. Specifically, the one or more embodiments provide a steering assist apparatus capable of selecting an appropriate mode from among a parking mode and an exit-from-parking-space mode as a steering assist mode in accordance with a peripheral state of a vehicle.

There is provided one embodiment of a steering assist apparatus (hereinafter also referred to as “embodiment apparatus”) applied to an own vehicle. The steering assist apparatus includes:
a detector (81, 82, 83, 84, 85) configured to detect an own-vehicle peripheral state including information on obstacles which are present in front and back of the own vehicle;
a steering assist device (10, 40, 41) configured to set a target path from a current position of the own vehicle to a predetermined target position based on the own-vehicle peripheral state detected by the detector, and to perform a steering assist control for assisting a steering operation of a driver in such a manner that the own vehicle travels along the target path;
an operation unit (86) to be operated by the driver to request execution of the steering assist control; and
a mode selector (10) configured to select, when the operation unit is operated, any one of a parallel exit-from-parking-space mode and a parking mode, the parallel exit-from-parking-space mode being a mode for performing the steering assist control when the own vehicle which has been parked in parallel to a travel direction of a road exits from a parking space, and the parking mode being a mode for performing the steering assist control when the own vehicle is parked.

Further, the mode selector is configured to select any one of the parallel exit-from-parking-space mode and the parking mode based on the own-vehicle peripheral state detected by the detector (Step 350, Step 360. and Step 370; Step 1070, Step 1060, and Step 1080; Step 1170, Step 1160, and Step 1180).

The steering assist device is configured to set, when the parallel exit-from-parking-space mode is selected, a position at which the own vehicle completes exiting from the parking space as the predetermined target position to perform the steering assist control, and to set, when the parking mode is selected, a position at which the own vehicle completes parking as the predetermined target position to perform the steering assist control.

The thus configured embodiment apparatus selects either the parking mode or the parallel exit-from-parking-space mode, as the steering assist mode, based on the peripheral state of the own vehicle, in particular, the detection result of obstacles in front and back of the own vehicle. The reason for this is as follows. That is, when the driver has operated the operation unit in a case where obstacles (for example, other vehicles) are present in front and back of the own vehicle (in a “region immediately in front and a region immediately back” of the own vehicle), it can be considered that the driver is requesting the steering assist not in the parking mode, but in the parallel exit-from-parking-space mode. In contrast, when the driver has operated the operation unit in a case where obstacles are not present in front and back of the own vehicle, it is considered that the driver is requesting the steering assist in the parking mode. In view of the above, the embodiment apparatus is configured to select, as the steering assist mode, the mode which the driver intends to choose, based on the detection result of obstacles in front and back of the own vehicle. As a result, the embodiment apparatus can select an appropriate mode as the steering assist mode.

More specifically, when the operation unit is operated in the state described above with reference to FIG. 5, obstacles are not present in front and back of the own vehicle, and therefore, the embodiment apparatus can select not the exit-from-parking-space mode, but the parking mode. Further, when the operation unit is operated in a state illustrated in FIG. 4 (i.e., in the state where the own vehicle which has been parked in parallel to a travel direction of a road exits from a parking space), obstacles (e.g. other vehicles) are present in front and back of the own vehicle, and therefore, the embodiment apparatus can select not the parking mode, but the parallel exit-from-parking-space mode.

In one aspect of the embodiment apparatus, the mode selector is configured to:
select the parallel exit-from-parking-space mode when a first condition, which is satisfied when the detector has detected obstacles both in front and back of the own vehicle, is satisfied (“Yes” at Step 350, and Step 360); and
select the parking mode when the first condition is not satisfied (“No” at Step 350, and Step 370).

In this aspect, when the first condition is satisfied, that is, when obstacles are detected both in front and back of the own vehicle, the parallel exit-from-parking-space mode is selected. In contrast, when the first condition is not satisfied, the parking mode is selected according to this aspect. For example, as described above, there is a case where the driver temporarily turns off the ignition switch of the own vehicle in front of his or her own house to carry out work (for example, work carried out by the driver to unload the vehicle, or work to open the gate of the garage). The driver turns on the ignition switch again after the driver finishes the work, and operates the operation unit in order to park the own vehicle. In this situation, the first condition is not satisfied, and the parking mode is thus selected. Thus, even in the state in which the driver temporarily turns off the ignition switch in front of his or her own house, this aspect can select the steering assist mode (namely, the parking mode) as intended by the driver (in conformity with the driver's intention).

In another aspect of the embodiment apparatus, the apparatus further includes a shift position detector (60, 61) configured to detect a position of a shift lever.

In this aspect, the mode selector is configured to:

(1) select the parking mode when a position of the shift lever (hereinafter referred to as “shift lever position upon operation”) detected by the shift position detector at a time point at which the operation unit is operated, is a position other than a parking position (for example, D or R) (“No” at Step 1050, and Step 1060); and

(2) when the shift lever position upon operation is the parking position (P):
(2a) select the parallel exit-from-parking-space mode when a first condition, which is satisfied when the detector has detected obstacles both in front and back of the own vehicle, is satisfied (“Yes” at Step 1050, “Yes” at Step 1070, and Step 1080); and
(2b) select the parking mode when the first condition is not satisfied (“Yes” at Step 1050, “No” at Step 1070, and Step 1060).

In this aspect, one mode from among the parking mode and the parallel exit-from-parking-space mode is selected as the steering assist mode based on the “shift lever position upon operation” and the peripheral state of the own vehicle at the time point at which the operation unit is operated. When the shift lever position upon operation is the parking position (P), it can be generally considered that the vehicle has been in the parking state (state in which the vehicle has completed the parking), and thus, it is preferable that the parallel exit-from-parking-space mode be selected. However, there is a case in which the driver temporarily stops the own vehicle in front of his or her own house, shifts the position of the shift lever to the parking position (P), and carries out the work described above. In such a case, when the driver gets in the own vehicle to operate the operation unit again, it is not appropriate to consider that the vehicle has been in the parking state so as to select the parallel exit-from-parking-space mode. Thus, in this aspect, even when the shift lever position upon operation is the parking position (P), the parking mode is selected when the first condition is not satisfied. Accordingly, this aspect can select the steering assist mode (namely, the parking mode) as intended by the driver (in conformity with the driver's intention).

In another aspect of the embodiment apparatus, the apparatus further includes:

a shift position detector (60, 61) configured to detect a position of a shift lever; and

a travel distance calculator (10, 30, 33) configured to calculate a travel distance of the own vehicle from a time point at which the position of the shift lever detected by the shift position detector is shifted to a reverse position (R).

In addition, the mode selector in this aspect is configured to:

(1) select the parking mode (Step 1160) when a shift lever position upon operation, which is a position of the shift lever detected by the shift position detector at a time point at which the operation unit is operated, is a position other than a parking position (P) (“No” at Step 1150); and

(2) when the selected shift lever position upon operation is the parking position (P) (“Yes” at Step 1150):
(2a) select (Step 1180) the parallel exit-from-parking-space mode when a first condition is satisfied, the first condition being a condition which is satisfied when the detector has detected obstacles both in front and back of the own vehicle (“Yes” at Step 1170); and
(2b) select the parallel exit-from-parking-space mode if a second condition is satisfied (“Yes” at Step 1190, and Step 1180) when the first condition is not satisfied (“No” at Step 1170), and select the parking mode if the second condition is not satisfied (“No” at Step 1190, and Step 1160) when the first condition is not satisfied (“No” at Step 1170), the second condition being a condition which is satisfied when the travel distance (L) calculated by the travel distance calculator is shorter than a predetermined distance threshold (α).

In general, when the driver parks the own vehicle in perpendicular or in parallel to a travel direction of a road, the driver shifts/moves the shift lever to the reverse position (R) at least once. Further, when the vehicle is currently in the parking/parked state (the position of the shift lever is the parking position (P)), a travel distance (L) after the shift lever was shifted/moved to the reverse position (R) should be shorter than the predetermined distance threshold (α). Thus, when the position of the shift lever is the parking position (P) and the travel distance (L) is shorter than the predetermined distance threshold (α), a probability that the own vehicle is currently in the parking state is high.

In view of the above, in the above-mentioned aspect, when the shift lever position upon operation is the parking position (P), a determination is made as to whether or not the own vehicle is in the parking state based on the travel distance (L) of the own vehicle after the shift lever is shifted to the reverse position (R), and one mode from among the exit-from-parking-space mode and the parking mode is selected as the steering assist mode based on the determination result.

As a result, in the above-mentioned aspect, even in a state in which the first condition is not satisfied (in the state in which obstacles are not detected both in front of and back of the own vehicle) (for example, even in a state in which an obstacle (another vehicle) is present only in front of the own vehicle or only in back of the own vehicle which has been parked in parallel to the travel direction of the road), the parallel exit-from-parking-space mode can automatically be selected.

In another aspect of the embodiment apparatus, the mode selector is configured to, in selecting the parking mode, determine which of perpendicular parking and parallel parking is possible based on the own-vehicle peripheral state detected by the detector, select a perpendicular parking mode as the parking mode when the perpendicular parking is determined to be possible, and select a parallel parking mode as the parking mode when the parallel parking is determined to be possible (Step 370, Step 1060, Step 1160, and routine of FIG. 6).

In this aspect, the steering assist device is further configured to: when the perpendicular parking mode is selected, set a position at which the own vehicle completes the perpendicular parking as the predetermined target position to perform the steering assist control; and when the parallel parking mode is selected, set a position at which the own vehicle completes the parallel parking as the predetermined target position to perform the steering assist control.

In this aspect, when the driver carries out any one of the parallel parking and the perpendicular parking, appropriate steering assist control can be carried out.

Further features relating to the above one or more aspects of the embodiment apparatus become apparent from the description herein and the accompanying drawings. Problems, configurations, and effects other than those described above become apparent from the following description of embodiments.

In the above description, in order to facilitate understanding of the above one or more aspect of the embodiment apparatus, a name and/or reference numeral used in embodiments described below is enclosed in parentheses and assigned to each of the constituent features corresponding to the embodiments. However, each of the constituent features is not limited to the embodiments defined by the name and/or reference numeral.

### BRIEF DESCRIPTION OF THE DRAWINGS

FIG. 1 is a schematic configuration diagram for illustrating a steering assist apparatus according to a first embodiment.

FIG. 2A is a plan view of a vehicle for illustrating an arrangement of clearance sonars, ultrasonic sensors, and cameras illustrated in FIG. 1.

FIG. 2B is a plan view for illustrating detection areas of the clearance sonars and the ultrasonic sensors illustrated in FIG. 1.

FIG. 3 is a flowchart for illustrating a mode selection routine to be executed by a steering assist ECU in the first embodiment.

FIG. 4 is a diagram for illustrating a state in which a vehicle is parked in parallel to a travel direction of a road (parallel parking).

FIG. 5 is a diagram for illustrating a state in which a vehicle stops temporarily in front of his or her own house.

FIG. 6 is a flowchart for illustrating a parking mode selection routine to be executed by the steering assist ECU in the first embodiment.

FIG. 7 is a diagram for illustrating a state in which a perpendicular parking mode is selected.

FIG. 8 is a diagram for illustrating a state in which a parallel parking mode is selected.

FIG. 9 is a flowchart for illustrating an assist termination determination routine to be executed by the steering assist ECU in the first embodiment.

FIG. 10 is a flowchart for illustrating a mode selection routine to be executed by the steering assist ECU in a second embodiment.

FIG. 11 is a flowchart for illustrating a mode selection routine to be executed by the steering assist ECU in a third embodiment.

FIG. 12 is a diagram for illustrating a state in which a vehicle is parked in parallel to a travel direction of a road (parallel parking) and an obstacle (another vehicle) is present only in a region in front of the vehicle.

### DESCRIPTION OF THE EMBODIMENTS

Now, referring to the accompanying drawings, a description is given of embodiments. The accompanying drawings are illustrations of one or more specific embodiments in conformity with the principle thereof, but those illustrations are mere examples to be used for the understanding of the embodiments, and are not to be used to limit the interpretation of the invention.

### First Embodiment

### (Configuration)

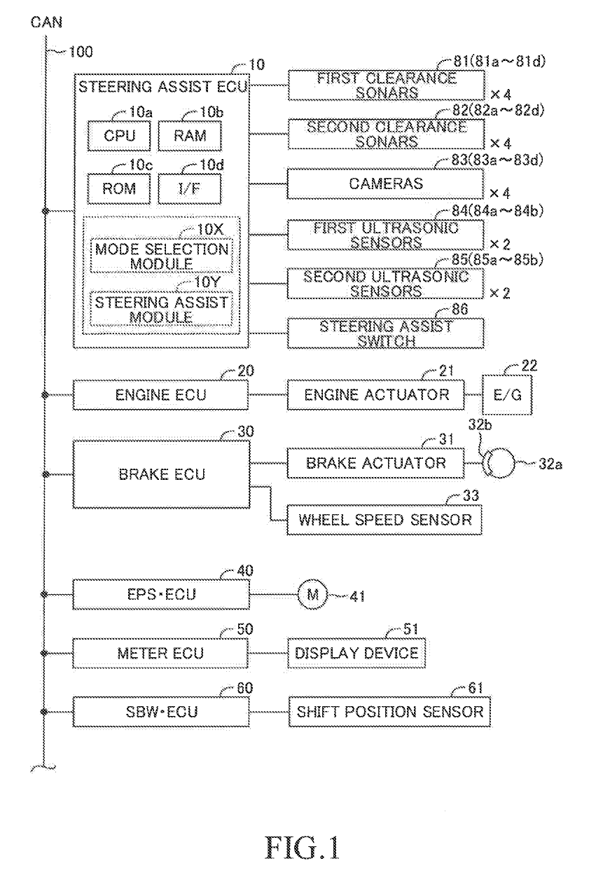

A steering assist apparatus (hereinafter also referred to as a “first apparatus”) according to a first embodiment is applied to a vehicle (hereinafter also referred to as an “own vehicle” in order to distinguish it from other vehicles). As illustrated in FIG. 1, the first apparatus includes a steering assist ECU 10 including a microcomputer as a principal component thereof. This microcomputer includes a CPU 10a, a RAM 10b, a ROM 10c, an interface (I/F) 10d, and the like. The CPU 10a is configured to execute instructions (programs and routines) stored in the ROM 10c to implement various functions. The ECU herein stands for “electric control unit”. The ECU includes a microcomputer including a CPU, a RAM, a ROM, an interface, and the like. The CPU is configured to execute instructions stored in the ROM to implement various functions.

The steering assist ECU 10 is connected to an engine ECU 20, a brake ECU 30, an electric power steering ECU (hereinafter referred to as an “EPS ECU”) 40, a meter ECU 50, and a shift-by-wire (SBW) ECU 60 via a controller area network (CAN) 100. Those ECUs are connected to one another so as to be capable of mutually transmitting and receiving information via the CAN 100. Thus, a detection value obtained by a sensor connected to a specific ECU of those ECUs is transmitted to ECUs other than the specific ECU.

The engine ECU 20 is connected to an engine actuator 21. The engine actuator 21 includes a throttle valve actuator configured to change an opening degree of a throttle valve of an internal combustion engine 22. The engine ECU 20 can change a torque generated by the internal combustion engine 22 through driving the engine actuator 21. Thus, the engine ECU 20 can control a driving force of the own vehicle through controlling the engine actuator 21. When the own vehicle is a hybrid vehicle, the engine ECU 20 can control a driving force of the own vehicle generated by any one of or both of “an internal combustion engine and a motor” serving as vehicle driving sources. Further, when the own vehicle is an electric vehicle, the engine ECU 20 can control a driving force of the own vehicle generated by a motor serving as a vehicle driving source.

The brake ECU 30 is connected to a brake actuator 31. The brake actuator 31 adjusts a hydraulic pressure of liquid to be supplied to wheel cylinders integrated into brake calipers 32b in accordance with an instruction from the brake ECU 30, so as to use the hydraulic pressure to press brake pads against brake discs 32a, to thereby generate friction braking forces. Thus, the brake ECU 30 can control a braking force of the own vehicle through controlling the brake actuator 31.

Further, the brake ECU 30 is connected to a wheel speed sensor 33 (in actuality, four wheel speed sensors provided for the respective wheels). The wheel speed sensor 33 is configured to generate a pulse signal every time the corresponding wheel rotates by a predetermined angle. The brake ECU 30 acquires a vehicle speed SPD of the own vehicle based on a signal transmitted from the wheel speed sensor 33. Thus, the steering assist ECU 10 can acquire information on the vehicle speed SPD via the CAN 100. In addition, the brake ECU 30 is configured to count (accumulates) the pulse signal output from the wheel speed sensor 33, to thereby calculate a travel distance of the own vehicle. Thus, the steering assist ECU 10 can acquire information on the travel distance of the own vehicle via the CAN 100.

The EPS ECU 40 is connected to an assist motor (M) 41. The assist motor 41 is integrated into a “steering mechanism including a steering wheel, a steering shaft coupled to the steering wheel, and a gear mechanism for steering” (not shown) of the vehicle. The EPS ECU 40 uses a steering torque sensor (not shown) provided in the steering shaft to detect a steering torque input to the steering wheel by the driver, to thereby drive the assist motor 41 based on the steering torque. The EPS ECU 40 applies a steering torque to the steering mechanism through the drive of the assist motor 41, to thereby assist the steering operation of the driver.

The meter ECU 50 is connected to a display device 51. The display device 51 is a multi-information display provided in front of a driver's seat. The display device 51 displays various types of information in addition to measurement values such as the vehicle speed and an engine revolution speed. The meter ECU 50 displays guidance relating to the assist for parking and exiting from a parking space in accordance with display instructions transmitted from the steering assist ECU 10. The display device 51 is not limited to the multi-information display, and may be a display dedicated for the assist for parking and exiting from a parking space. A head-up display may be employed as the display device 51.

The SBW ECU 60 is connected to a shift position sensor 61. The shift position sensor 61 detects a position of a shift lever serving as a movable portion of a shift operation unit. In this example, positions of the shift lever include a parking position (P), a drive position (D), and a reverse position (R). The SBW ECU 60 is configured to receive the position of the shift lever from the shift position sensor 61 to control a transmission and/or driving-direction switching mechanism (not shown) of the own vehicle based on the shift lever position. More specifically, when the position of the shift lever is “P”, the SBW ECU 60 controls the transmission and/or driving-direction switching mechanism in such a manner that the driving force is not transmitted to drive wheels and the vehicle is thus mechanically locked to a stop position. When the position of the shift lever is “D”, the SBW ECU 60 controls the transmission and/or driving-direction switching mechanism in such a manner that the driving force for moving the own vehicle forward is transmitted to the drive wheels. Further, when the position of the shift lever is “R”, the SBW ECU 80 controls the transmission and/or driving-direction switching mechanism in such a manner that the driving force for moving the own vehicle backward is transmitted to the drive wheels. The SBW ECU 60 is configured to output to the steering assist ECU 10 a signal indicative of the position of the shift lever received from the shift position sensor 61.

A plurality of first clearance sonars 81a to 81d, a plurality of second clearance sonars 82a to 82d, a plurality of cameras 83a to 83d, a plurality of first ultrasonic sensors 84a and 84b, a plurality of second ultrasonic sensors 85a and 85b, and a steering assist switch 86 are connected to the steering assist ECU 10. The plurality of first clearance sonars 81a to 81d are generally referred to as “first clearance sonars 81”. The plurality of second clearance sonars 82a to 82d are generally referred to as “second clearance sonars 82”. The plurality of cameras 83a to 83d are generally referred to as “cameras 83”. The plurality of first ultrasonic sensors 84a and 84b are generally referred to as “first ultrasonic sensors 84”. The plurality of second ultrasonic sensors 85a and 85b are generally referred to as “second ultrasonic sensors 85”.

Each of the first clearance sonars 81 and the second clearance sonars 82 (hereinafter generally referred to as “clearance sonars” when the sonars are not required to be distinguished from each other) transmits an ultrasonic wave having a pulse form in a predetermined range, and receives a reflected wave reflected by an obstacle. The clearance sonar detects absence/presence of an obstacle and a distance to the obstacle based on a period from the transmission of the ultrasonic wave to the reception of the ultrasonic wave. The obstacle is, for example, a parked vehicle, a guard rail, a utility pole, or a curb. The clearance sonar is used to detect an obstacle at a position relatively close to the vehicle.

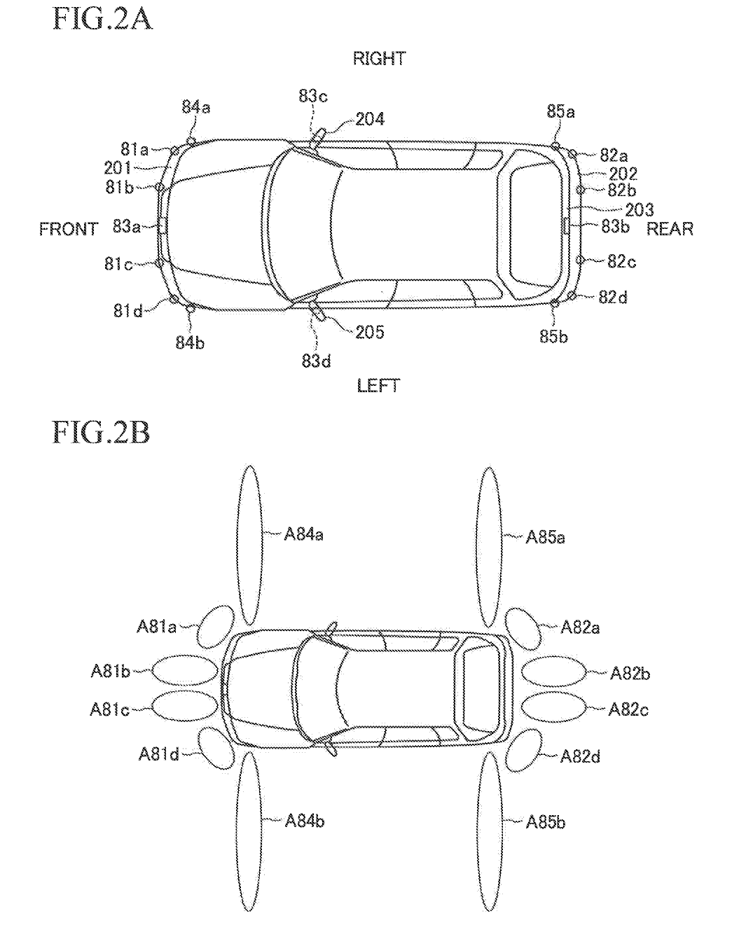

As illustrated in FIG. 2A, in the first embodiment, the four first clearance sonars 81a to 81d are mounted to a front bumper 201 in a front part of a vehicle body at intervals in a vehicle widthwise direction. In FIG. 2B, reference symbols A81a, A81b, A81c, and A81d indicate detection areas of the first clearance sonar 81a, the first clearance sonar 81b, the first clearance sonar 81c, and the first clearance sonar 81d, respectively. Thus, each of the first clearance sonars 81 (81a to 81d) can detect absence/presence of an obstacle in front of the vehicle, and a distance to the obstacle.

As further illustrated in FIG. 2A, the four second clearance sonars 82a to 82d are mounted to a rear bumper 202 in a rear part of the vehicle body at intervals in the vehicle widthwise direction. In FIG. 2B, reference symbols A82a, A82b, A82c, and A82d indicate detection areas of the second clearance sonar 82a, the second clearance sonar 82b, the second clearance sonar 82c, and the second clearance sonar 82d, respectively. Thus, each of the second clearance sonars 82 (82a to 82d) can detect absence/presence of an obstacle in the back of the vehicle, and a distance to the obstacle.

Each of the plurality of cameras 83a to 83d is a digital camera incorporating an image pickup device such as a charge coupled device (CCD) and a CMOS image sensor (CIS). Each of the cameras 83a to 83d outputs image data at a predetermined frame rate. An optical axis of each of the cameras 83a to 83d is set obliquely downward from the vehicle body of the vehicle. Thus, each of the cameras 83a to 83d picks up an image of a peripheral state (including an obstacle, a parking-possible region in which the vehicle can be parked, and an exit-possible region to which the vehicle can be moved from a parking space) of the vehicle to be checked when the vehicle is parked or exits from the parking space, and outputs data on the obtained image.

As illustrated in FIG. 2A, in the first embodiment, the camera 83a is mounted to substantially a center part of the front bumper 201 in the vehicle widthwise direction, and acquires image data in front of (ahead of) the vehicle. The camera 83b is mounted to a wall part of a rear trunk 203 in the rear part of the vehicle, and acquires image data in the back of the vehicle. The camera 83c is mounted to a door mirror 204 on a right side of the vehicle, and acquires image data on the right side of the vehicle. The camera 83d is mounted to a door mirror 205 on a left side of the vehicle, and acquires image data on the left side of the vehicle.

Each of the first ultrasonic sensors 84 and the second ultrasonic sensors 85 (hereinafter generally referred to as “ultrasonic sensors” when the ultrasonic sensors are not required to be distinguished from each other) transmits an ultrasonic wave having a pulse form in a predetermined range, and receives a reflected wave reflected by an obstacle. The ultrasonic sensor detects absence/presence of an obstacle and a distance to the obstacle based on a period from the transmission of the ultrasonic wave to the reception of the ultrasonic wave. The ultrasonic sensor is used to detect an obstacle at a position relatively far from the vehicle compared with the clearance sonar.

As illustrated in FIG. 2A, the first ultrasonic sensor 84a is mounted at a position on the right side of the front part of the vehicle (for example, an end on the right side of the front bumper 201). In FIG. 2B, reference symbol A84a indicates a detection area of the first ultrasonic sensor 84a. Thus, the first ultrasonic sensor 84a can detect absence/presence of an obstacle on the right side of the front side of the vehicle, and a distance to the obstacle. Further, the first ultrasonic sensor 84b is mounted at a position on the left side of the front part of the vehicle (for example, an end on the left side of the front bumper 201). In FIG. 2B, reference symbol A84b indicates a detection area of the first ultrasonic sensor 84b. Thus, the first ultrasonic sensor 84b can detect absence/presence of an obstacle on the left side of the front side of the vehicle, and a distance to the obstacle.

As illustrated in FIG. 2A, the second ultrasonic sensor 85a is mounted at a position on the right side of the rear portion of the vehicle (for example, an end on the right side of the rear bumper 202). In FIG. 2B, reference symbol A85a indicates a detection area of the second ultrasonic sensor 85a. Thus, the second ultrasonic sensor 85a can detect absence/presence of an obstacle on the right side of the rear side of the vehicle, and a distance to the obstacle. Further, the second ultrasonic sensor 85b is mounted at a position on the left side of the rear portion of the vehicle (for example, an end on the left side of the rear bumper 202). In FIG. 2B, reference symbol A85b indicates a detection area of the second ultrasonic sensor 85b. Thus, the second ultrasonic sensor 85b can detect absence/presence of an obstacle on the left side of the rear side of the vehicle, and a distance to the obstacle.

The steering assist ECU 10 receives the detection signal from each of the first clearance sonars 81, the second clearance sonars 82, the first ultrasonic sensors 84, and the second ultrasonic sensors 85 every time a predetermined period elapses. The steering assist ECU 10 converts information (namely, a position of a reflection point, which is a point at which the transmitted ultrasonic wave is reflected) contained in each of the detection signals into coordinates in a two-dimensional map in which a position of the own vehicle and a travel direction of the own vehicle are set as references. The steering assist ECU 10 detects a “region in which obstacles are not present” in a periphery of the own vehicle based on a shape of a group of the reflection points on the two-dimensional map. The steering assist ECU 10 extracts a region having a size which is large enough for the own vehicle to be parked (or a region to which the own vehicle can be moved from the parking space) in the two-dimensional map. The region extracted as the region in which the own vehicle can be parked (or to which the own vehicle can be moved from the parking space) is hereinafter referred to as “candidate region”.

The steering assist ECU 10 acquires the image data from each of the cameras 83 every time a predetermined period elapses. The steering assist ECU 10 analyzes the image data from each of the cameras 83, to thereby detect obstacles which are present in the periphery of the own vehicle. Further, when partition lines (white lines) drawn/painted on a road surface are detected in the image data from each of the cameras 83, the steering assist ECU 10 extracts a region surrounded by the detected partition lines as a “candidate region”.

The steering assist switch 86 illustrated in FIG. 1 is a switch to be operated (pressed or depressed) when the driver instructs the ECU 10 to start the steering assist control. The steering assist switch 86 is configured to transmit (generate) an ON signal (high-level signal) during a period in which the steering assist switch 86 is being depressed, and to transmit (generate) an OFF signal (low-level signal) during a period in which the steering assist switch 86 is not depressed. The steering assist switch 86 may have a function of stopping and resuming the steering assist control and a function of switching a mode.

### (Overview of Operation)

As described later, the steering assist ECU 10 selects any one of a parking mode and an exit-from-parking-space mode (i.e., either the parking mode or the exit-from-parking-space mode) as a steering assist mode when the signal from the steering assist switch 86 changes from the OFF signal to the ON signal as a result of the depression of the steering assist switch 86. The parking mode includes a perpendicular parking mode and a parallel parking mode. In this manner, the steering assist ECU 10 includes a “mode selection module (mode selector) 10X configured to select the assist mode” implemented by the CPU 10a in terms of its function.

The perpendicular parking mode is a mode for performing the steering assist when the own vehicle is parked in a direction perpendicular to the travel direction of a road. The perpendicular parking is synonymous with moving the own vehicle backward to park the own vehicle in parallel to other parked vehicles. More specifically, the perpendicular parking is an operation of parking the own vehicle in such a manner that one side surface of the own vehicle is opposed to one side surface of another vehicle (first another vehicle), the other side surface of the own vehicle is opposed to one side surface of still another vehicle (second another vehicle), and a longitudinal axis passing through the center in the widthwise direction of the own vehicle and longitudinal axes passing through the centers in the widthwise direction of the first and second another vehicles are parallel to each other. The perpendicular parking mode is also a mode for performing the steering assist when the own vehicle is parked in such a manner that at least one of the left and right side surfaces of the own vehicle is opposed to a white line, a wall, a fence, a guard rail, or the like. The perpendicular parking mode in this example is not applied to a case in which the own vehicle is parked while the own vehicle is being moved forward.

The parallel parking mode is a mode for performing the steering assist when the own vehicle is parked in a direction parallel to the travel direction of the road. The parallel parking is synonymous with parking the own vehicle to be line with other vehicle parked along the travel direction of the road. More specifically, the parallel parking is an operation of parking the own vehicle in such a manner that the front end portion of the own vehicle is opposed to the rear end portion (or front end portion) of the first another vehicle, the rear end portion of the own vehicle is opposed to the front end portion (or rear end portion) of the second another vehicle, and the longitudinal axis passing through the center in the widthwise direction of the own vehicle and the longitudinal axes passing through the centers in the widthwise direction of the first and second another vehicles are substantially on the same line.

The exit-from-parking-space mode includes only a parallel exit-from-parking-space mode. The parallel exit-from-parking-space mode is a mode for performing the steering assist when the own vehicle parked by the “parallel parking” exits from the parking space (moves out to the road).

When the parking mode is selected, the steering assist ECU 10 determines a candidate region as a parking-possible region, and selects any one of the perpendicular parking mode and the parallel parking mode based on the size of the parking-possible region as described later. The steering assist ECU 10 sets a target position, which is a position of the own vehicle at the time of completion of the parking, in the parking-possible region in any one of the perpendicular parking mode and the parallel parking mode. The steering assist ECU 10 calculates a target path for moving the own vehicle from the current position to the target position. For example, the target path is the shortest path along which the own vehicle can move from the current position to the target position while a predetermined clearance is provided/secured between the vehicle body of the own vehicle and obstacles (for example, other vehicles, curbs, or guard rails). Various methods are known to calculate the target path, and any one of the methods may be selected. For example, a calculation method for the target path proposed in Japanese Patent Application Laid-open No. 2015-3565 may be employed.

When a path for moving the own vehicle to the target position through one backward movement cannot be calculated as the target path, the steering assist ECU 10 calculates a path for repeating the backward movement and the forward movement as the target path.

The steering assist ECU 10 calculates a steering angle pattern for moving the own vehicle along the target path. The steering angle pattern is data that associates a position of the own vehicle and a steering angle on the target path with each other, and indicates a change in the steering angle when the own vehicle travels on the target path.

When the calculation of the target path and the steering angle pattern is completed, the steering assist ECU 10 transmits a guidance display command/instruction to the meter ECU 50. The meter ECU 50 causes the display device 51 to display a guidance relating to the parking assist for the own vehicle in accordance with the guidance display command/instruction. For example, the steering assist ECU 10 causes the display device 51 to display a guidance indicating that the own vehicle is required to move backward via the meter ECU 50 as the guidance relating to the parking assist. The driver moves the shift lever to the reverse position (R) in accordance with this guidance. When the shift lever is moved to the reverse position (R), the steering assist ECU 10 starts the steering assist. Specifically, the steering assist ECU 10 transmits a steering control signal (target steering angle) to the EPS ECU 40 in accordance with the target path and the steering angle pattern. The EPS ECU 40 drives the assist motor 41 in accordance with the steering control signal transmitted from the steering assist ECU 10. As a result of the automatic steering control (steering assist) being executed in this manner, the driver can park the own vehicle at the target position without operating the steering wheel by himself or herself.

When the exit-from-parking-space mode is selected, the steering assist ECU 10 also performs a similar automatic steering control (steering assist). Specifically, when the exit-from-parking-space mode is selected, the steering assist ECU 10 selects the candidate region as the exit-possible region, and determines the target position in the exit-possible region. The target position is the position of the own vehicle at the time of completion of exiting from a parking space. The steering assist ECU 10 calculates a target path and a steering angle pattern of moving the own vehicle from the current position to the target position. Then, for example, the steering assist ECU 10 causes the display device 51 to display a guidance indicating that the own vehicle is required to move forward or backward via the meter ECU 50 as the guidance relating to the exit-from-parking-space mode. The driver moves the shift lever in accordance with this guidance. When the shift lever is moved to an appropriate position from among the drive position (D) and the reverse position (R), the steering assist ECU 10 transmits a steering control signal to the EPS ECU 40 in accordance with the target path and the steering angle pattern. The EPS ECU 40 performs the automatic steering control in accordance with the steering control signal transmitted from the steering assist ECU 10. In this manner, the steering assist ECU 10 includes a “steering assist module (part of steering assist device) 10Y configured to perform the above-mentioned steering assist control” implemented by the CPU 10a in terms of function.

The steering assist ECU 10 may automatically perform a shift control by using the SBW ECU 60, a driving force control by using the engine ECU 20, and a braking force control by using the brake ECU 30 in addition to the automatic steering control. For example, the steering assist ECU 10 may transmit a shift control signal to the SBW ECU 60 when the own vehicle reaches a position on the target path at which the movement direction of the own vehicle is to be switched between the backward direction and the forward direction, to thereby cause the SBW ECU 60 to perform the shift control. Further, the steering assist ECU 10 may calculate a speed pattern for causing the own vehicle to travel along the target path. The speed pattern is data that associates the position of the own vehicle on the target path and a travel speed with each other, and indicates a change in the travel speed when the own vehicle travels on the target path. The steering assist ECU 10 may transmit a braking force control signal to the brake ECU 30 in accordance with the speed pattern, to thereby cause the brake ECU 30 to perform the braking force control. Further, the steering assist ECU 10 may transmit a driving force control signal to the engine ECU 20 in accordance with the speed pattern, to thereby cause the engine ECU 20 to perform the driving force control.

### (Concrete Operation of First Apparatus)

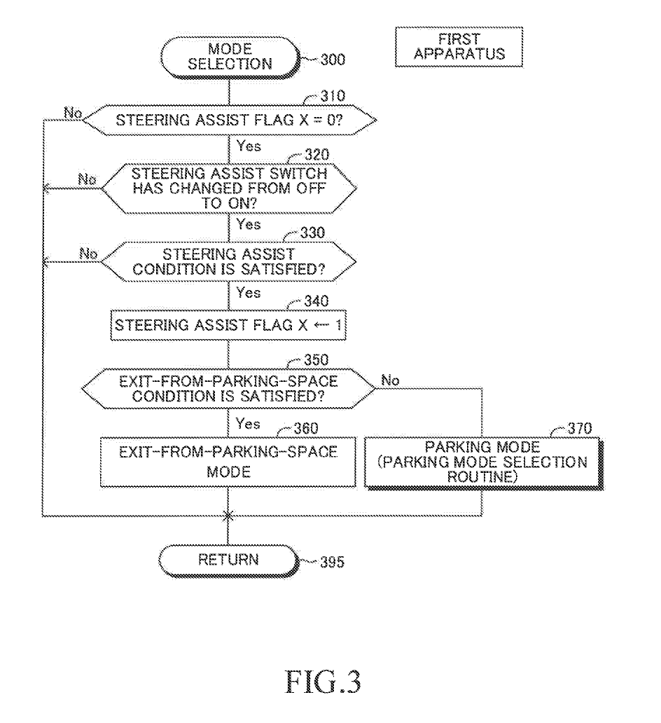

A description is now given of an operation to be performed when the steering assist ECU 10 (mode selection module of the steering assist ECU 10) selects the above-mentioned steering assist mode. The CPU 10a (hereinafter simply referred to as a “CPU”) of the steering assist ECU 10 is configured to execute a “mode selection routine” illustrated in FIG. 3 every time a predetermined period elapses. Further, as described above, the CPU executes a routine (not shown), every time a predetermined period elapses, to detect and acquire information on the peripheral state (obstacles and a region (candidate region) without the obstacles) of the own vehicle, using the signals from the first clearance sonars 81, the second clearance sonars 82, the cameras 83, the first ultrasonic sensors 84, and the second ultrasonic sensors 85.

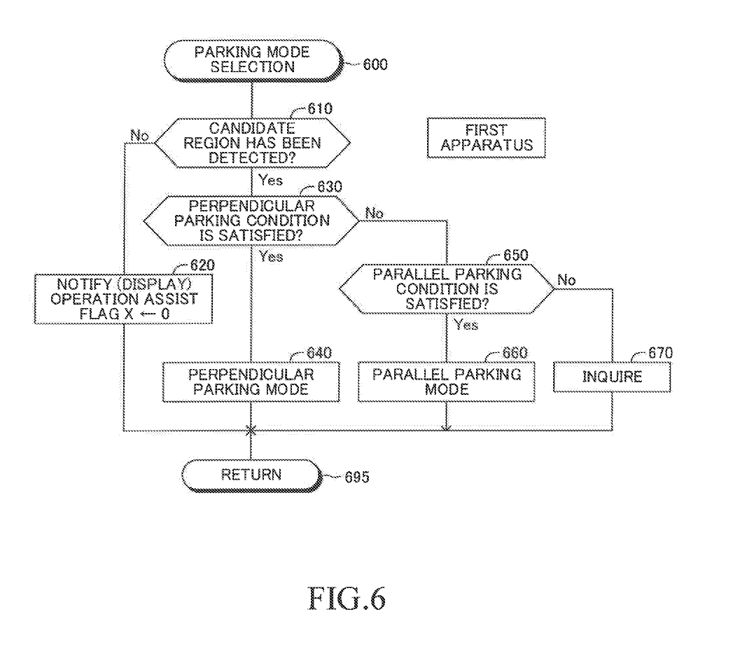

The CPU starts processing from Step 300 of FIG. 3 at a predetermined timing, and proceeds to Step 310 to determine whether or not a value of a steering assist flag X is “0”. The value of the steering assist flag X is set to “0” in an initialization routine executed by the CPU when an ignition switch (not shown) (or a start switch of a driving system, such as a Hybrid system) is changed from an off state to an on state. Further, the value of the steering assist flag X is set to “0” also at Step 620 of FIG. 6 described later.

When it is assumed that the value of the steering assist flag X is “0”, at Step 310, the CPU makes a “Yes” determination, and proceeds to Step 320 to determine whether or not the current time point is a “time point immediately after the signal from the steering assist switch 86 changes from the OFF signal to the ON signal” (that is, whether or not the steering assist switch 86 is depressed). The “time point immediately after the signal from the steering assist switch 86 changes from the OFF signal to the ON signal” is hereinafter also referred to as a “time point immediately after the turning-on”.

When the current time point is the time point immediately after the turning-on (that is, the time point immediately after the driver depressed the steering assist switch 86), at Step 320, the CPU makes a “Yes” determination, and proceeds to Step 330 to determine whether or not a steering assist condition is satisfied. For example, the steering assist condition is satisfied when the current vehicle speed SPD is equal to or lower than a predetermined speed threshold (for example, 30 km/h).

When the steering assist condition is satisfied, at Step 330, the CPU makes a “Yes” determination, and proceeds to Step 340 to set the value of the steering assist flag X to “1”. Then, the CPU proceeds to Step 350 to determine whether or not a predetermined exit-from-parking-space condition is satisfied based on the signals from the first clearance sonars 81a to 81d, the second clearance sonars 82a to 82d, the camera 83a, and the camera 83b. The exit-from-parking-space condition is also referred to as “first condition” for the sake of convenience. The exit-from-parking-space condition is a condition satisfied when both of Condition 1 and Condition 2 given below are satisfied.

(Condition 1) At least one of the first clearance sonars 81a to 81d and the camera 83a has detected an obstacle within a predetermined distance from the own vehicle. In other words, an obstacle is present within a first-distance range from the own vehicle in front of (ahead of) the own vehicle.
(Condition 2) At least one of the second clearance sonars 82a to 82d and the camera 83b has detected an obstacle within a predetermined distance from the own vehicle. In other words, an obstacle is present within a second-distance range from the own vehicle in the back of the own vehicle.

When the exit-from-parking-space condition is satisfied, at Step 350, the CPU makes a “Yes” determination, and proceeds to Step 360 to select the exit-from-parking-space mode (parallel exit-from-parking-space mode) as the steering assist mode.

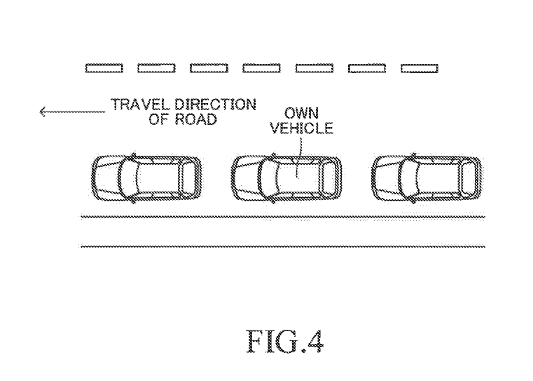

The above-mentioned exit-from-parking-space condition is satisfied when obstacles have been detected within the predetermined distance from the own vehicle both in front and back of the own vehicle. As illustrated in FIG. 4, in a state in which the own vehicle is parked in a direction parallel to a travel direction of a road, obstacles (other vehicles) have been detected both in front and back of the own vehicle. When the steering assist switch 86 is depressed in this state, the driver is considered to have requested the steering assist while intending to receive the assist in the parallel exit-from-parking-space mode. Thus, when the exit-from-parking-space condition is satisfied, that is, only when obstacles are present both in front and back of the own vehicle, the first apparatus selects the exit-from-parking-space mode.

In contrast, when the exit-from-parking-space condition is not satisfied, at Step 350, the CPU makes a “No” determination, and proceeds to Step 370 to select the parking mode as the steering assist mode. More specifically, at Step 370, the CPU executes a “parking mode selection routine” illustrated in FIG. 6, to thereby select any one of the perpendicular parking mode and the parallel parking mode as the steering assist mode. Then, the CPU proceeds to Step 395 to terminate this routine.

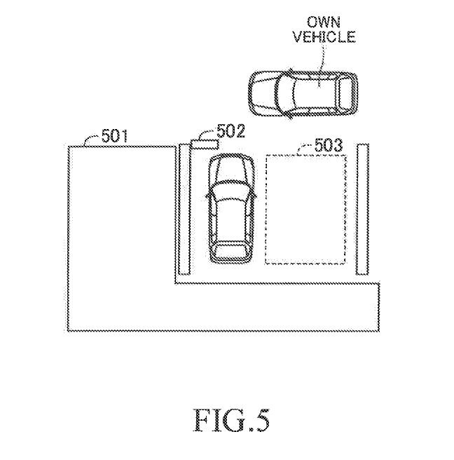

In this manner, when the exit-from-parking-space condition is not satisfied, the first apparatus selects the parking mode (either the perpendicular parking mode or the parallel parking mode). Meanwhile, as illustrated in FIG. 5, there is a case where the driver temporarily turns off the ignition switch of the own vehicle in front of his or her own house 501, and carries out work (for example, work carried out by the driver to unload the vehicle, or work to open a gate 502 of a garage). In this case, when the driver finishes the work and gets on the own vehicle again to depress the steering assist switch 86, it is preferable/appropriate that not the exit-from-parking-space mode but the parking mode be selected as the steering assist mode. In the state of FIG. 5, when the steering assist switch 86 is depressed, since the exit-from-parking-space condition is not satisfied, and the first apparatus thus selects the parking mode as described above. Therefore, the first apparatus can select an appropriate mode from among the parking mode and the exit-from-parking-space mode as the steering assist mode in accordance with the peripheral state of the vehicle.

It should be noted that when the value of the steering assist flag X is not “0” at the time point at which the CPU executes the processing of Step 310, the CPU makes a “No” determination at Step 310, and directly proceeds to Step 395 to tentatively terminate this routine. Further, when the time point at which the CPU executes the processing of Step 320 is not the “time point immediately after the turning-on”, the CPU makes a “No” determination at Step 320, and directly proceeds to Step 395 to tentatively terminate this routine. In addition, when the steering assist condition is not satisfied at the time point at which the CPU executes the processing of Step 330, the CPU makes a “No” determination at Step 330, and directly proceeds to Step 395 to tentatively terminate this routine.

Referring to a flowchart of FIG. 6, a description is now given of an operation to be performed when the steering assist ECU 10 selects any one of the perpendicular parking mode and the parallel parking mode as the parking mode. As described above, when the CPU proceeds to Step 370 of FIG. 3, the CPU starts processing of the “parking mode selection routine” illustrated in FIG. 6 from Step 600, and proceeds to Step 610 to determine whether or not a candidate region has been detected. The candidate region is a region having a size enough for the own vehicle to be parked as described above. When the candidate region has not been detected, the CPU makes a “No” determination at Step 610, and proceeds to Step 620. At Step 620, the CPU cancels the selection of the parking mode as the steering assist mode and displays a notice of “Candidate region is not detected” on the display device 51 to notify the driver of this fact, and sets the value of the steering assist flag X to “0”. Then, the CPU proceeds to Step 395 of FIG. 3 via Step 695. In this case, no mode is selected as the steering assist mode, and thus, the automatic steering control (steering assist) is not performed.

Meanwhile, when the candidate region has been detected, the CPU makes a “Yes” determination at Step 610, and proceeds to Step 630 to determine whether or not a perpendicular parking condition is satisfied. For example, the perpendicular parking condition is a condition satisfied when both of Condition 3 and Condition 4 given below are satisfied.

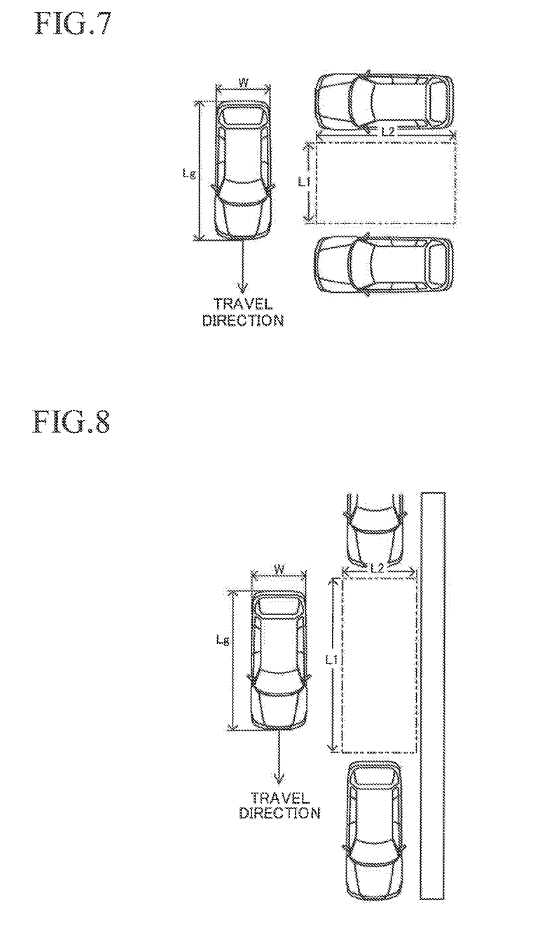

(Condition 3) A “length (L1 shown in FIG. 7) along the travel direction of the own vehicle” of the candidate region is equal to or longer than a first predetermined length and is shorter than a second predetermined length. For example, the first predetermined length is a value obtained by adding a first margin (minimum length required for a driver or passenger to get in or get out of the vehicle) to a length W in the vehicle widthwise direction of the own vehicle. For example, the second predetermined length is a length Lg of the own vehicle in the front-rear direction.
(Condition 4) A “minimum length (for example, L2 shown in FIG. 7) in a direction (direction departing from the own vehicle, i.e., a depth direction) orthogonal to the travel direction of the own vehicle” of the candidate region is equal to or longer than a third predetermined length. For example, the third predetermined length is a value obtained by adding a second margin to the length Lg in the front-rear direction of the own vehicle. The “minimum length (for example, L2 shown in FIG. 7)” herein refers to a “length in the depth direction of the region that has been successfully detected as the candidate region based on the signals from the first clearance sonars 81, the second clearance sonars 82, the cameras 83, the first ultrasonic sensors 84, and the second ultrasonic sensors 85”. In other words, the candidate region may actually be longer in the depth direction than the minimum length thereof. This holds true for Condition 6 described later. For example, the second margin is a minimum required length to be secured between the own vehicle and an obstacle which is present in the front-rear direction of the own vehicle.

When the perpendicular parking condition is satisfied as illustrated in FIG. 7, the CPU makes a “Yes” determination at Step 630, and proceeds to Step 640 to select the perpendicular parking mode as the parking mode. Then, the CPU proceeds to Step 395 of FIG. 3 via Step 695.

In contrast, when the perpendicular parking condition is not satisfied, the CPU makes a “No” determination at Step 630, and proceeds to Step 650 to determine whether or not a parallel parking condition is satisfied. For example, the parallel parking condition is a condition satisfied when both of Condition 5 and Condition 6 given below are satisfied.

(Condition 5) The “length (L1 shown in FIG. 8) along the travel direction of the own vehicle” of the candidate region is equal to or longer than the third predetermined length.
(Condition 6) The “minimum length (for example, L2 shown in FIG. 8) in the direction (direction departing from the own vehicle, i.e., the depth direction) orthogonal to the travel direction of the own vehicle” of the candidate region is equal to or longer than the first predetermined length and is shorter than the second predetermined length.

When the parallel parking condition is satisfied as illustrated in FIG. 8, the CPU makes a “Yes” determination at Step 650, and proceeds to Step 660 to select the parallel parking mode as the parking mode. Then, the CPU proceeds to Step 395 of FIG. 3 via Step 695.

Meanwhile, when the parallel parking condition is not satisfied, at Step 650, the CPU makes a “No” determination, and proceeds to Step 670. For example, when both of the “length along the travel direction of the own vehicle” of the candidate region and the “minimum length in the direction (depth direction) orthogonal to the travel direction of the own vehicle” of the candidate region are equal to or longer than the third predetermined length (for example, value obtained by adding the second margin to the length Lg in the front-rear direction of the own vehicle), the CPU proceeds to Step 670. In this case, both of the perpendicular parking and the parallel parking can be carried out for the candidate region. Thus, at Step 670, the CPU displays a screen for asking the driver to select either the perpendicular parking mode or the parallel parking mode on the display device 51, and lets the driver select any one of the modes. The driver operates a selection switch (not shown) (or liquid crystal touch panel) to select any one of the perpendicular parking mode and the parallel parking mode. Then, the CPU selects the selected one of the perpendicular parking mode and the parallel parking mode as the parking mode.

It should be noted that a prioritized mode from among the perpendicular parking mode and the parallel parking mode may be set in advance. In this case, at Step 670, the CPU may notify the driver of the mode having a higher priority on the display device 51, and may ask the driver whether or not the driver accepts the mode (having a higher priority).

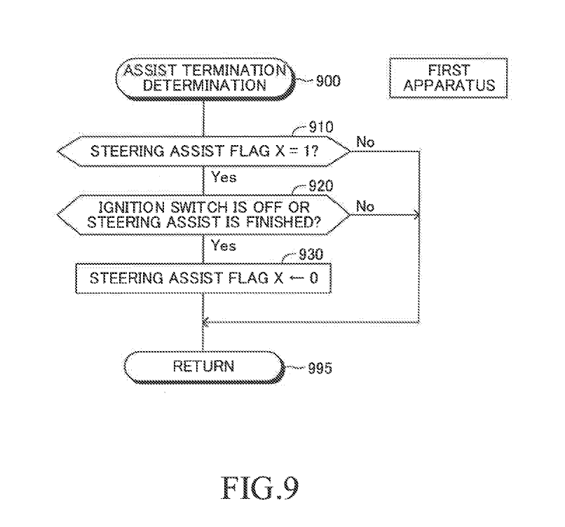

Further, the CPU is configured to execute an “assist termination determination routine” illustrated in FIG. 9 every time a predetermined period elapses. Thus, the CPU starts processing from Step 900 of FIG. 9 at a predetermined timing, and proceeds to Step 910 to determine whether or not the value of steering assist flag X is “1”. When the value of the steering assist flag X is not “1”, the CPU makes a “No” determination at Step 910, and directly proceeds to Step 995 to tentatively terminate this routine.

In contrast, when the value of the steering assist flag X is “1”, the CPU makes a “Yes” determination at Step 910, and proceeds to Step 920 to determine whether or not at least one of Condition 7 and Condition 8 given below is satisfied.

(Condition 7) The ignition switch is in the off state.
(Condition 8) The current (present) time point is a time point immediately after the steering assist has just been finished/completed. The steering assist is finished when the own vehicle reaches the target position, which is a position to be reached when the own vehicle completes parking to the parking space in the parking mode or exiting from the parking-space in the exit-from-parking-space mode. The CPU may be configured to finish/complete the steering assist also when a “specific operation for stopping the steering assist is performed on the steering assist switch 86”.

When neither Condition 7 nor Condition 8 is satisfied, the CPU makes a “No” determination at Step 920, and directly proceeds to Step 995 to tentatively terminate this routine.

To the contrary, when at least one of Condition 7 and Condition 8 is satisfied, the CPU makes a “Yes” determination at Step 920, and proceeds to Step 930 to set the value of the steering assist flag X to “0”. Thus, after this time point, the CPU repeatedly makes a “Yes” determination at Step 310 of FIG. 3. Therefore, when the steering assist switch 86 is depressed again, the CPU starts the selection of (or processing for selecting) the steering assist mode (“Yes” at Step 320).

As described above, when the steering assist is requested through the operation on the steering assist switch 86, the first apparatus selects the steering assist mode from among the exit-from-parking-space mode and the parking mode (perpendicular parking mode or parallel parking mode) in accordance with the recognition result of the region (candidate region) in which the obstacles are not present. Thus, an appropriate mode can be selected as the steering assist mode.

### Second Embodiment

A description is now given of a steering assist apparatus (hereinafter also referred to as a “second apparatus”) according to a second embodiment. The second apparatus is different from the first apparatus mainly in that the mode is selected based on the position of the shift lever and the peripheral state of the own vehicle. A description is now mainly given of this difference.

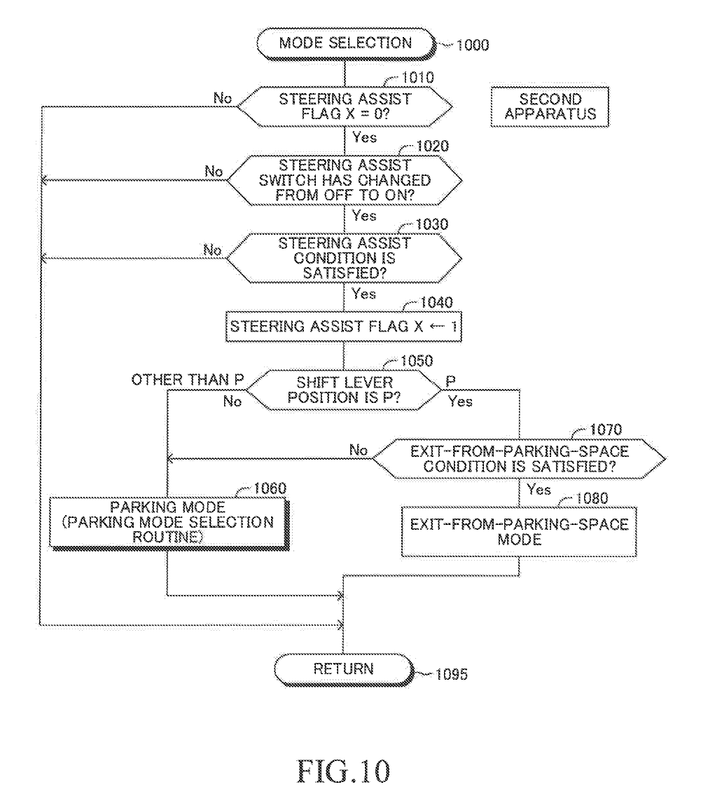

The CPU of the steering assist ECU 10 of the second apparatus is configured to execute a “mode selection routine” illustrated in FIG. 10 in place of the routine illustrated in FIG. 3 every time a predetermined period elapses. Further, the CPU executes a routine (not shown) every time a predetermined period elapses to detect and acquire the peripheral state (obstacles and a region (candidate region) without the obstacles) of the own vehicle, using the signals from the first clearance sonars 81, the second clearance sonars 82, the cameras 83, the first ultrasonic sensors 84, and the second ultrasonic sensors 85 as described above. In addition, the CPU is configured to execute the “assist termination determination routine” illustrated in FIG. 9 every time the predetermined period elapses.

The CPU starts processing from Step 1000 of FIG. 10 at a predetermined timing. Details of Step 1010 to Step 1040 are the same as the details of Step 310 to Step 340 of FIG. 3, respectively, and a description thereof is therefore omitted. A description is now given of processing from Step 1050.

At Step 1050, the CPU acquires from the SBW ECU 60 the information on the position (a current position of the shift lever, that is, a shift lever position upon operation) of the shift lever at a time point at which the steering assist switch 86 was depressed, and determines whether or not the current position of the shift lever (the shift lever position upon operation) is the parking position (P). When the current position of the shift lever is a position other than the parking position (P) (for example, any one of the drive position (D) and the reverse position (R)), the CPU proceeds to Step 1060 to select the parking mode. At Step 1060, the CPU executes the “parking mode selection routine” illustrated in FIG. 6. Then, the CPU proceeds to Step 1095 of FIG. 10 via Step 695 of FIG. 6 to tentatively terminate this routine.

In contrast, when the current position of the shift lever is the parking position (P), the CPU proceeds from Step 1050 to Step 1070 to determine whether or not an exit-from-parking-space condition is satisfied. The exit-from-parking-space condition is the same as the above-mentioned exit-from-parking-space condition.

When the exit-from-parking-space condition is satisfied, the CPU makes a “Yes” determination at Step 1070, and proceeds to Step 1080 to select the exit-from-parking-space mode (parallel exit-from-parking-space mode). Thereafter, the CPU proceeds to Step 1095 to tentatively terminate this routine.

Meanwhile, when the exit-from-parking-space condition is not satisfied, the CPU makes a “No” determination at Step 1070, and proceeds to Step 1060 to select the parking mode. As described above, at Step 1060, the CPU executes the “parking mode selection routine” illustrated in FIG. 6. Then, the CPU proceeds to Step 1095 of FIG. 10 via Step 695 of FIG. 6 to tentatively terminate this routine.

In this manner, when the steering assist is requested though the operation on the steering assist switch 86, the second apparatus selects one of the parking mode and the exit-from-parking-space mode as the steering assist mode based both on the current position of the shift lever and the peripheral state of the vehicle. Thus, the second apparatus can select an appropriate mode as the steering assist mode. The reason for this is that, when the current position of the shift lever is a position other than the parking position (P) (namely, the drive position (D) or the reverse position (R)), the driver is considered to have depressed the steering assist switch 86 while intending to receive the parking assist. Thus, the second apparatus selects the parking mode in this case.

In contrast, when the current position of the shift lever is the parking position (P), the vehicle is considered to usually be in the parking/parked state (state of the completion of the parking). However, as described above with reference to FIG. 5, there is a case in which the driver temporarily stops the own vehicle in front of his or her own house 501, shifts the position of the shift lever to the parking position (P), and carries out the work described above. In this state, when the driver finishes the work and gets in the own vehicle again to depress the steering assist switch 86, it is preferable/appropriate that not the exit-from-parking-space mode but the parking mode be selected as the steering assist mode. From this viewpoint, when the steering assist switch 86 is depressed in the state shown in FIG. 5, the second apparatus selects the parking mode unless an obstacle is detected both in front and back of the own vehicle (i.e., unless the exit-from-parking-space condition is satisfied) even when the current position of the shift lever is the parking position (P). Thus, the second apparatus selects an appropriate mode from among the parking mode and the exit-from-parking-space mode as the steering assist mode in accordance with the peripheral state of the vehicle.

### Third Embodiment

A description is now given of a steering assist apparatus (hereinafter also referred to as a “third apparatus”) according to a third embodiment. The third apparatus is different from the first apparatus and the second apparatus mainly in that the mode is selected based on the position of the shift lever, the peripheral state of the own vehicle, and operation history of the shift lever. A description is now mainly given of this difference.

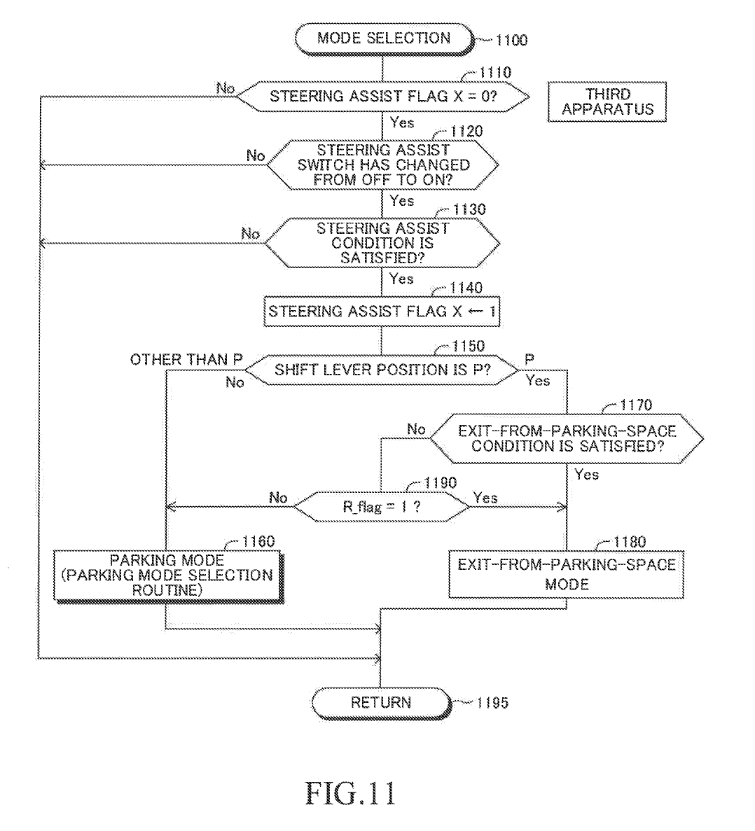

First, a description is given of processing to be executed by the steering assist ECU 10 of the third apparatus to monitor the operation history of the shift lever. The steering assist ECU 10 utilizes a flag (R_flag) indicating that the shift lever is shifted to the reverse position (R). The flag (R_flag) is a flag to be used to determine whether or not the own vehicle is currently in the parking state. When the flag (R_flag) is “1”, the flag (R_flag) indicates that the own vehicle is currently in the parking state. When the flag (R_flag) is “0”, the flag (R_flag) indicates that the own vehicle is not in the parking state. The flag (R_flag) is used in a “mode selection routine” illustrated in FIG. 11 described later.

The steering assist ECU 10 acquires information on the current position of the shift lever from the SBW ECU 60 every time a predetermined period elapses. When the position of the shift lever is shifted from a “position other than the reverse position (R)” to the “reverse position (R)”, the steering assist ECU 10 sets the flag (R_flag) to “1”. The steering assist ECU 10 stores the value of the flag (R_flag) in a nonvolatile memory (not shown). In other words, the steering assist ECU 10 can maintain the value of the flag (R_flag) even during a period in which the ignition switch is in the off state.

The steering assist ECU 10 calculates a travel (moving) distance L from a time point at which the shift lever is shifted to the reverse position (R). In order to calculate the travel distance L, the steering assist ECU 10 acquires information on a “travel distance in the last predetermined period” of the own vehicle from the brake ECU 30 via the CAN 100 every time the predetermined period elapses. The steering assist ECU 10 integrates the “travel distance in the last predetermined period” received from the brake ECU 30 from the time point at which the position of the shift lever is shifted (changed) to the reverse position (R), to thereby calculate the travel distance L from the time point at which the position of the shift lever is shifted (changed) to the reverse position (R). Hereinafter, the travel distance L from the time point at which the position of the shift lever is shifted (changed) to the reverse position (R) is simply referred to as a “travel distance L”.

The steering assist ECU 10 may acquire information on the travel distance from one or both of the other ECUs (engine ECU 20 and meter ECU 50). For example, the meter ECU 50 calculates a travel distance based on the pulse signal output from the wheel speed sensor 33, and displays the travel distance of the own vehicle on the display device 51. Thus, the steering assist ECU 10 may acquire the information on the travel distance from the meter ECU 50.

The steering assist ECU 10 sets the flag (R_flag) to “0” at a time point at which the travel distance L becomes equal to or longer than a predetermined distance threshold α (for example, several meters to ten meters). In other words, the value of the flag (R_flag) continues being “1” while the travel distance L after the shift lever is shifted to the reverse position (R) is shorter than the predetermined distance threshold α. In general, when the driver parks the own vehicle in perpendicular or in parallel to the travel direction of the road, the driver shifts the shift lever to the reverse position (R) at least once. Further, when the vehicle is currently in the parking/parked state (i.e. when the position of the shift lever is the parking position (P)), the travel distance L after the shift lever is shifted to the reverse position (R) should be shorter than the predetermined distance threshold α. Thus, when the position of the shift lever is the parking position (P) and the flag (R_flag) is “1”, the steering assist ECU 10 determines that the own vehicle is highly likely to be in the parking state currently.

On the other hand, the driver may move backward the own vehicle (drive the own vehicle in reverse) for a purpose other than the purpose of parking the own vehicle. For example, the driver may temporarily move the own vehicle backward in order to change the direction of the own vehicle. In this case, the travel distance after the change of direction becomes longer, and the travel distance L thus becomes longer than the predetermined distance threshold α after the time point at which the position of the shift lever is shifted to the reverse position (R). Thus, the value of the flag (R_flag) becomes “0” in this case. When the own vehicle is moved backward for a purpose (for example, changing the direction) other than the parking in the above manner, the value of the flag (R_flag) is set to “0” at a time point at which the own vehicle travels over a distance equal to or longer than the predetermined distance threshold α. In view of the above, when the position of the shift lever is the parking position (P), the steering assist ECU 10 refers to the value of the flag (R_flag), to thereby more accurately determine whether or not the own vehicle is currently in the parking state.

The steering assist ECU 10 resets the travel distance L (that is, sets L to 0) every time the shift lever is shifted to the reverse position (R). In other words, the steering assist ECU 10 calculates the travel distance L from the (last) time point at which the shift lever was lastly shifted to the reverse position (R).

A description is now given of an operation to be performed when the third apparatus selects the steering assist mode. The steering assist ECU 10 of the third apparatus is configured to execute the “mode selection routine” illustrated in FIG. 11 in place of the routines illustrated in FIGS. 3 and 10 every time a predetermined period elapses. Further, the CPU detects and acquires the peripheral state (obstacles and a region (candidate region) without the obstacles) of the own vehicle every time a predetermined period elapses in the same manner as the CPUs of the first apparatus and the second apparatus. Further, the CPU executes a routine (not shown) to set the value of the flag (R_flag). In addition, the CPU is configured to execute the “assist termination determination routine” illustrated in FIG. 9 every time the predetermined period elapses.

The CPU starts processing from Step 1100 of FIG. 11 at a predetermined timing. Details of Step 1110 to Step 1140 are the same as the details of Step 310 to Step 340 of FIG. 3, respectively, and a description thereof is therefore omitted. A description is now given of processing from Step 1150.

At Step 1150, the CPU acquires from the SBW ECU 60 the information on the position (the current position of the shift lever, that is, the shift lever position upon operation) of the shift lever at a time point at which the steering assist switch 86 was depressed, and determines whether or not the current position of the shift lever (the shift lever position upon operation) is the parking position (P). When the current position of the shift lever (the shift lever position upon operation) is a position other than the parking position (P) (for example, any one of the drive position (D) and the reverse position (R)), the CPU proceeds to Step 1160 to select the parking mode. At Step 1160, the CPU executes the “parking mode selection routine” illustrated in FIG. 6. Then, the CPU proceeds to Step 1195 of FIG. 11 via Step 695 of FIG. 6 to tentatively terminate this routine.

In contrast, when the current position of the shift lever is the parking position (P), the CPU proceeds from Step 1150 to Step 1170 to determine whether or not the exit-from-parking-space condition is satisfied. The exit-from-parking-space condition is the same as the above-mentioned exit-from-parking-space condition.

When the exit-from-parking-space condition is satisfied, the CPU makes a “Yes” determination at Step 1170, and proceeds to Step 1180 to select the exit-from-parking-space mode (parallel exit-from-parking-space mode). Then, the CPU proceeds to Step 1195 to terminate this routine.

When the exit-from-parking-space condition is not satisfied, the CPU makes a “No” determination at Step 1170, and proceeds to Step 1190 to determine whether or not the flag (R_flag) is “1”. The condition relating to the flag (R_flag) at Step 1190 is also referred to as “second condition” for the sake of convenience. When the flag (R_flag) is “1”, the CPU makes a “Yes” determination at Step 1190, and proceeds to Step 1180 to select the exit-from-parking-space mode (parallel exit-from-parking-space mode). Then, the CPU proceeds to Step 1195 to tentatively terminate this routine.

In contrast, when the flag (R_flag) is not “1”, the CPU makes a “No” determination at Step 1190, and proceeds to Step 1160 to select the parking mode. At Step 1160, the CPU executes the “parking mode selection routine” illustrated in FIG. 6. Then, the CPU proceeds to Step 1195 of FIG. 11 via Step 695 of FIG. 6 to tentatively terminate this routine.

The thus configured third apparatus determines whether or not the own vehicle is in the parking state based further on the travel distance L of the own vehicle after the shift lever was shifted to the reverse position (R). Thus, even when the position of the shift lever is the parking position (P) and the above-mentioned exit-from-parking-space condition is not satisfied (for example, an obstacle (another vehicle) is present only in front or back of the own vehicle parked in parallel to the travel direction of the road), the third apparatus can select the exit-from-parking-space mode as the steering assist mode based on the value of the flag (R_flag).

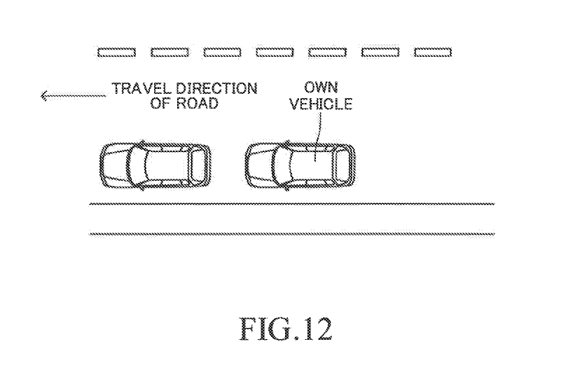

For example, as illustrated in FIG. 12, a case is considered where after the own vehicle was parked in parallel to the travel direction of the road, a vehicle in the back of the own vehicle has moved away. In this case, another vehicle is present only in front of the own vehicle. In this state, when the steering assist switch 86 is depressed, the position of the shift lever is the parking position (P), and the value of the flag (R_flag) is “1”. In this case, the exit-from-parking-space condition is not satisfied, but the value of the flag (R_flag) is “1”, and thus, the third apparatus selects the exit-from-parking-space mode (parallel exit-from-parking-space mode) (“No” at Step 1170, “Yes” at Step 1190, and Step 1180). In this manner, the third apparatus determines whether or not the own vehicle is in the parking state based also on the value of the flag (R_flag). Therefore, an appropriate mode can be selected from among the parking mode and the exit-from-parking-space mode as the steering assist mode.

Meanwhile, as described above with reference to FIG. 5, there is a case in which the driver temporarily stops the own vehicle in front of his or her own house 501, and shifts the position of the shift lever to the parking position (P) to carry out the work. In this case, the driver has not yet moved the own vehicle backward in front of the own house 501, and the value of the flag (R_flag) is thus “0”. Accordingly, when the driver again gets in the own vehicle after the work is finished and depresses the steering assist switch 86, the third apparatus selects the parking mode (“No” at Step 1190 and Step 1160). Thus, the third apparatus can select the parking mode along the driver's intention even in the state illustrated in FIG. 5. When the driver moves the own vehicle forward (without shifting the position of the shift lever to R) for parking (note that, the driver rarely moves the own vehicle forward for the parallel parking), the value of the flag (R_flag) is “0”. Thus, when the steering assist switch 86 is depressed in this state, the CPU of the third apparatus proceeds to Step 1150, Step 1170, Step 1190, and Step 1160 in the stated order, and ends up selecting the parking mode. However, such a case is rare, and if the driver does not want the selected steering assist (parking assist), the driver is only required to cancel the steering assist.

The present invention is not limited to the embodiments described above, and various modification examples can be adopted within the scope of the present invention.

For example, the parking mode may further include a forward-moving perpendicular parking mode for performing the steering assist when the driver moves forward the own vehicle and parks the own vehicle in such a manner that the longitudinal direction of the own vehicle and the longitudinal direction of another vehicle are parallel to each other. Further, the steering assist switch 86 is a switch configured to transmit (generate) the ON signal (high-level signal) when the steering assist switch 86 is depressed (the steering assist switch 86 is pushed down), and generate the OFF signal in the period in which the steering assist switch 86 is not depressed, but may be a switch of a different type. In other words, the steering assist switch 86 is only required to be a switch to be operated when the driver requests the steering assist to generate a signal indicating the request. Further, the steering assist switch may be an apparatus configured to use a speech recognition apparatus to recognize an oral (voice) request from the driver for the steering assist. This speech recognition apparatus is equivalent to a switch to be operated through speech (oral sound), and can serve as the operation switch (operation unit) in the above embodiments.

What is claimed is:

1. A steering assist apparatus applied to an own vehicle, comprising:
a detector configured to detect an own-vehicle peripheral state including information on obstacles present in front and back of the own vehicle;
a steering assist device configured to set a target path from a current position of the own vehicle to a predetermined target position based on the own-vehicle peripheral state detected by the detector, and to perform a steering assist control for assisting a steering operation of a driver in such a manner that the own vehicle travels along the target path;
an operation unit to be operated by the driver to request execution of the steering assist control; and
a mode selector configured to select, when the operation unit is operated, any one of a parallel exit-from-parking-space mode and a parking mode, the parallel exit-from-parking-space mode being a mode for performing the steering assist control when the own vehicle which has been parked in parallel to a travel direction of a road exits from a parking space, and the parking mode being a mode for performing the steering assist control when the own vehicle is parked,
wherein the mode selector is configured to select any one of the parallel exit-from-parking-space mode and the parking mode based on the own-vehicle peripheral state detected by the detector, and
wherein the steering assist device is configured to set, when the parallel exit-from-parking-space mode is selected, a position at which the own vehicle completes exiting from the parking space as the predetermined target position to perform the steering assist control, and to set, when the parking mode is selected, a position at which the own vehicle completes parking as the predetermined target position to perform the steering assist control.

2. The steering assist apparatus according to claim 1, wherein the mode selector is configured to:
select the parallel exit-from-parking-space mode when a first condition, which is satisfied when the detector has detected obstacles both in front and back of the own vehicle, is satisfied; and
select the parking mode when the first condition is not satisfied.

3. The steering assist apparatus according to claim 1, further comprising a shift position detector configured to detect a position of a shift lever,
wherein the mode selector is configured to:
select the parking mode when a shift lever position upon operation, which is a position of the shift lever detected by the shift position detector at a time point at which the operation unit is operated, is a position other than a parking position; and
when the shift lever position upon operation is the parking position:
select the parallel exit-from-parking-space mode when a first condition, which is satisfied when the detector has detected obstacles both in front and back of the own vehicle, is satisfied; and
select the parking mode when the first condition is not satisfied.

4. The steering assist apparatus according to claim 1, further comprising:
a shift position detector configured to detect a position of a shift lever; and
a travel distance calculator configured to calculate a travel distance of the own vehicle from a time point at which the position of the shift lever detected by the shift position detector is shifted to a reverse position,
wherein the mode selector is configured to:
select the parking mode when a shift lever position upon operation, which is a position of the shift lever detected by the shift position detector at a time point at which the operation unit is operated, is a position other than a parking position; and
when the shift lever position upon operation is the parking position:
select the parallel exit-from-parking-space mode when a first condition is satisfied, the first condition being a condition which is satisfied when the detector has detected obstacles both in front and back of the own vehicle; and
select the parallel exit-from-parking-space mode if a second condition is satisfied when the first condition is not satisfied, and select the parking mode if the second condition is not satisfied when the first condition is not satisfied, the second condition being a condition which is satisfied when the travel distance calculated by the travel distance calculator is shorter than a predetermined distance threshold.

5. The steering assist apparatus according to claim 1,
wherein the mode selector is configured to, in selecting the parking mode,
determine which of perpendicular parking and parallel parking is possible based on the own-vehicle peripheral state detected by the detector,
select a perpendicular parking mode as the parking mode when the perpendicular parking is determined to be possible, and
select a parallel parking mode as the parking mode when the parallel parking is determined to be possible, and
wherein the steering assist device is configured to:
set, when the perpendicular parking mode is selected, a position at which the own vehicle completes the perpendicular parking as the predetermined target position to perform the steering assist control; and
set, when the parallel parking mode is selected, a position at which the own vehicle completes the parallel parking as the predetermined target position to perform the steering assist control.
